(19) United States
(12) Patent Application Publication
(10) Pub. No.: US 2020/0090089 A1
(43) Pub. Date: Mar. 19, 2020

(54) ADAPTIVE SYSTEMS AND METHODS FOR REDUCING OCCURRENCE OF UNDESIRABLE CONDITIONS

(71) Applicant: Accenture Global Solutions Limited, Dublin (IE)

(72) Inventors: Chad Aston, Sonoma, CA (US); Claire Jacobson, San Francisco, CA (US); Joseph Getz, San Francisco, CA (US)

(73) Assignee: Accenture Global Solutions Limited, Dublin (IE)

(21) Appl. No.: 16/554,175

(22) Filed: Aug. 28, 2019

Related U.S. Application Data
(60) Provisional application No. 62/732,068, filed on Sep. 17, 2018.

(51) Int. Cl. G06Q 10/06

(52) U.S. Cl. CPC G06Q 10/0635; G06Q 10/06311; G06Q 10/0633

(57) ABSTRACT

Systems, apparatuses, and methods directed to one or more sensors configured to detect data related to at least one of a patient, an environment to which the patient is exposed, and an environmental resource, obtain the detected data, and transmit the detected data. The system also comprises a server configured to receive the detected data, the server comprising: a receiver configured to receive the detected data; and a processor coupled to a memory, the processor configured to: calculate a risk score for the detected data; calculate an overall risk score based on the risk score for the detected data; and determine one or more actions to be performed based on at least the overall risk score, the one or more actions reducing risk value, the risk value identifying the likelihood that the patient will contract a hospital acquired condition (HAC) or a hospital acquired infection (HAI).

### FIELD OF THE DISCLOSURE

This disclosure generally relates to methods, systems, apparatuses, and computer readable media for reducing the occurrence of undesirable conditions.

### BACKGROUND

Hospitals and similar environments have recurring problems with hospital acquired conditions (HACs). In 2015, the annual medical costs related to HACs ranged from $28 to $45 billion. According to a 2018 Centers for Disease Control and Prevention (CDC) Progress Report, approximately 1 in 31 United States hospital patients has at least one hospital acquired infection (HAI) contracted during the course of their hospital care. Such HAIs are only a subset of the HACs. The CDC report estimated that with a more robust infection monitoring system, the rates of certain HAIs could decrease by 70%. There are no such existing systems that provide a benefit of automatically adapting over time, and calculating, developing, and determining optimal solutions in a health-care related environment to reduce an occurrence of HACs/HAIs as the system detects changing risk factors and/or new risk factors. Conventional methods for addressing the long felt and continual need to reduce the occurrence of HAIs simply involve the manual sterilization of health-care related environments. Health care facilities have attempted to incorporate devices to eradicate bacteria including UV technologies (such as XENEX and SURFACIDE), cold air plasma devices (such as Sterionics and Plasma Technologies), and hand washing monitors (such as BIOVIGIL or SwipeSense).

Additionally, the CDC has instated public health environmental cleaning programs to manage hospital cleanliness. Reporting modules have also been developed by the CDC to monitor HAI incidence and Standardized Infection Ratios (SIRs), and to isolate the areas of the hospital needing attention.

Conventional methods, however, do not apply robust, specially implemented and programmed, solution-driven systems, methods, and apparatuses providing adaptability, automation, efficacy, and the opportunity to create objective learning opportunities for the health care providers (HCPs) to address HACs/HAIs, as described in the exemplary embodiments below.

### SUMMARY

Consistent with the disclosure, exemplary embodiments of systems, apparatuses, and methods thereof for reducing occurrences of HACs, are disclosed.

According to an embodiment, there is provided a system which may include: one or more sensors configured to: detect data related to at least one of: a patient, an environment to which the patient is exposed, and an environmental resource, obtain the detected data, and transmit the detected data; and a server configured to receive the detected data. The server may include: a receiver configured to: receive the detected data; and a processor coupled to a memory. The processor may be configured to: calculate a risk score for the detected data, the risk score related to at least one of: the patient, the environment to which the patient is exposed, or the environmental resource; calculate an overall risk score based on the risk score for the detected data; and determine one or more actions to be performed based on the overall risk score, the one or more actions reducing risk value. The risk value may identify the likelihood that the patient will contract a hospital acquired condition (HAC) or a hospital acquired infection (HAI).

An environmental resource may also be referred to as a facilities resource, an infrastructure resource, or a cleaning resource. Furthermore, the environmental resource may be a person or a robot.

The respective data may relate to each of the patient, the environment to which the patient is exposed, and the environmental resource.

Prior to determining the one or more actions to be performed based on at least the overall risk score, the processor may analyze at least one of the one or more actions and interactions of patients, the environment and/or a health care worker (HCW) to predict an effect of the at least one of the one or more actions.

The one or more sensors may include at least one of a hand wash sensor configured to detect information related to handwashing of the environmental resource, a room sensor configured to detect how effective the environmental resource cleans the room of the patient, and a time sensor configured to detect a duration of time the environmental resource spends in the room of the patient. The sensors in the patient room may detect data from the environmental resource as well as people who enter and exit the room (e.g., family members, environmental services (EVS) workers, etc.).

According to another embodiment, there is provided a method which may include: receiving detected data related to at least one of a patient, an environment to which the patient is exposed, and an environmental resource; calculating a risk score for each of the detected data related to the at least one of the patient, the environment to which the patient is exposed, and the environmental resource; calculating an overall risk score based on the risk score for each of the detected data; and determining one or more actions to be performed based on at least the overall risk score, the one or more actions reducing risk value. The risk value may identify the likelihood that the patient will contract a hospital acquired condition (HAC) or a hospital acquired infection (HAI).

The respective data may relate to each of the patient, the environment to which the patient is exposed, and the environmental resource.

The method may further include acquiring the data using at least a patient monitoring sensor, an environment sensor, and an environmental resource.

The method may further include, prior to the determining operation, analyzing at least one of the one or more actions to predict an effect of at least one of the one or more actions.

The patient monitoring sensor may include at least one of a respiration monitor, a blood pressure monitor, a body temperature monitor, and a telemetry monitor. The environment sensor may include at least one of a virus detector, a bacteria detector, and fungi sensor, and the environment sensor may include at least one of a hand wash sensor configured to detect information related to handwashing of an environmental resource, a room sensor configured to detect how effective the environmental resource cleans the room of the patient, and a time sensor configured to detect a duration of time the environmental resource spends in the room of the patient.

According to another embodiment, there is provided an apparatus which may include: a receiver configured to receive detected data related to at least one of a patient, an environment to which the patient is exposed, or an environmental resource; and logic coupled to the receiver, wherein the logic is implemented in one or more of configurable logic or fixed-functionality hardware logic, the logic configured to: calculate a risk score for each of the detected data related to the at least one of the patient, the environment to which the patient is exposed, or the environmental resource; calculate an overall risk score based on the risk score for each of the detected data; and determine one or more actions to be performed based on at least the overall risk score, the one or more actions reducing risk value. The risk value may identify the likelihood that the patient will contract a hospital acquired condition (HAC) or a hospital acquired infection (HAI).

The respective data is acquired using a patient monitoring sensor, an environment sensor, and an environmental resource sensor.

Prior to determining the one or more actions to be performed based on at least the overall risk score, the logic analyzes at least one of the one or more actions to predict an effect of the at least one of the one or more actions.

The patient monitoring sensor may include at least one of a respiration monitor, a blood pressure monitor, a body temperature monitor, and a telemetry monitor. The environment sensor may include at least one of a virus detector, a bacteria detector, and fungi sensor, and the environmental resource sensor may include at least one of a hand wash sensor configured to detect information related to handwashing of the environmental resource, a room sensor configured to detect how effective the environmental resource cleans the room of the patient, and a time sensor configured to detect a duration of time the environmental resource spends in the room of the patient.

According to yet another embodiment, there is provided a non-transitory computer readable medium comprising a set of instructions, which when executed by one or more processors of a device, cause the device to: receive detected data related to at least one of a patient, an environment to which the patient is exposed, or an environmental resource; calculate a risk score for each of the detected data related to the at least one of the patient, the environment to which the patient is exposed, or the environmental resource; calculate an overall risk score based on the risk score for each of the detected data; and determine one or more actions to be performed based on at least the overall risk score. The one or more actions may reduce a risk value, where the risk value identifies the likelihood that the patient will contract a hospital acquired condition (HAC) or a hospital acquired infection (HAI).

It is to be understood that both the foregoing general description and the following detailed description are exemplary and explanatory only and are not restrictive of the invention, as claimed.

### BRIEF DESCRIPTION OF THE DRAWINGS

The various embodiments will become apparent to one skilled in the art by reading the following specification and appended claims, and by referencing the following drawings, in which:

The various embodiments will become apparent to one skilled in the art by reading the following specification and appended claims, and by referencing the following drawings, in which:

FIGS. 1A and 1B illustrate a schematic diagram of an overall system architecture according to an exemplary embodiment;

FIG. 2 illustrates a method of determining a patient risk score according to an exemplary embodiment;

FIG. 3 illustrates a block diagram of an apparatus according to an exemplary embodiment;

FIG. 4 illustrates a method of determining an employee risk score according to an exemplary embodiment;

FIG. 5 illustrates a method of determining an environment risk score according to an exemplary embodiment;

FIGS. 6A-6B illustrate a method of detecting risk factors, assessing various risk scores, and calculating and developing optimal actions to be taken based on the risk scores, according to an exemplary embodiment;

FIGS. 7A-7D illustrate interfaces of an app for an EVS worker according to an exemplary embodiment;

FIGS. 8A-8C illustrate interfaces of an app for a nurse according to an exemplary embodiment;

FIG. 9 illustrates an interface of an app for an infection control officer according to an exemplary embodiment.

### DESCRIPTION OF THE EMBODIMENTS

While the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” an illustrative embodiment,” etc., indicate that the embodiment described may include a particular feature, structure, or characteristic, but every embodiment may or may not necessarily include that particular feature, structure, or characteristic. Further, when a particular feature, structure, or characteristic is described in connection with an embodiment, it is submitted that it is within the knowledge of one skilled in the art to affect such feature, structure, or characteristic in connection with other embodiments whether or not explicitly described.

The disclosed embodiments may be implemented, in some cases, in hardware, firmware, software, or any combination thereof. The disclosed embodiments may also be implemented as instructions carried by or stored on a machine readable (e.g., computer-readable) medium or machine readable storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

HACs contribute to increased duration of patient stay, incur a greater cost to hospitals, and can even lead to patient death. Exemplary embodiments disclosed herein employ machine learning (ML) algorithms to solve one or more of the problems caused by HACs. While there are many confounding environmental and patient factors that can increase the likelihood of a HAI, which is a type of HAC, a goal of applying ML to HAIs aims to identify key variables causing increased rates of infection to eliminate risk factors before a patient suffers from an infection. Machine learning provides computers and/or systems the ability to learn without being explicitly programmed.

Some pathogens of concern in the acquisition of HAIs include methicillin resistant staph (MRSA/MSSA), Clostridioides difficile (CD), vancomycin-resistant staphylococcus (VRS), vancomycin-resistant enterococci (VRE), candida bloodstream infections, other bacteria that fall under the multi-site gram negative bacteria protocol, among other infections. Exemplary areas or objects of concern for cleaning in a hospital or health-care environment include the IV pump, monitors, touch screens, cables, and ventilation controls.

Exemplary embodiments bring together disparate patient data sources and combine patient data with data pertaining to environmental conditions related to one or more environmental resources (e.g., employees, HCW, health care providers (HCPs)), environmental resource protocols and cleanliness criteria of spaces and objects in an environment, to better track the risk of HACs. By capturing data related to, for example, patient history and conditions, environmental resource traffic and protocols, and real-time environmental feedback, exemplary embodiments generate a robust data set of factors that have been empirically shown to increase the risk of HACs. Algorithm-based automated technical analysis and measurement of each of these factors allow the system to continuously train itself and learn more about how these factors interplay and affect the risk of acquiring specific HACs, using artificial intelligence (AI) and ML algorithms. As a result, algorithms used in exemplary embodiments become smarter and more accurate over time.

Systems, apparatuses, and methods according to exemplary embodiments may capture, for example, three types of data: patient, environmental, and environmental resource data. Patient data may include demographic data (e.g., age, region, socio-economic, etc.), historical data (e.g., existing conditions, past surgeries, past interactions, past outcomes, family history, prior hospitalizations, etc.), and real-time conditions (e.g., reason for hospitalization, vital signs, weight, height, etc.). Environmental data may include historical data and real-time conditions related to the environment of a patient. Environmental resource data may include data related to the occupation of an environmental resource, the responsibilities of the environmental resource, historical and real-time conditions of the environmental resource. The patient data may be passed through an ML algorithm and a patient risk score may be calculated. In a similar manner, an environmental risk score and an environmental resource risk score may be calculated based on environmental data and environmental resource data, all using one or more ML algorithms to continuously train the system as it aggregates additional data. Although three types of data are disclosed, exemplary embodiments are not limited to only the disclosed types of data. Various other types of data may be used in accordance with exemplary embodiments. The total number of types of data may be greater than or less than the three types of data disclosed above.

According to an exemplary embodiment, patient, environment, and environmental resource data may be collected in various ways.

For the patient residing in the room, skin temperature, heart rate, age, ethnicity, reason for hospitalization, patient history, and/or any other EMR room data may be combined. A device, processor and/or system according to an exemplary embodiment may calculate an overall risk score based upon these parameters. This score may use a linear regression. The model may then be used to calculate an overall risk score for the patient based on the actual data collected. Additionally, if a patient is high-risk for a condition, a sensitivity analysis using, for example, a machine learning model may be created/built and executed to discover which variables have the greatest influence on the score. According to an exemplary embodiment, a device, processor, and/or system may optimize which tasks should be performed and prioritize the order of tasks to lower the risk score. A head nurse or EVS officer may then review and delegate the recommended tasks to an appropriate available worker. These tasks may include, e.g., moving a patient, changing their medication, having a medical professional perform a procedure, etc.

For the environment, room, or the area being examined, the temperature, humidity, last date cleaned, materials used, protocol followed, and bacterial surface scores may be detected and/or obtained. To gather bacterial surface scores, a bacterial level reader may be attached to or incorporated in a phone or tablet. This may allow the device to quickly test the surface and utilize the phone/tablet camera to identify what the surface is, using vision APIs and a neural network. This may allow a device, processor, and/or system to easily ensure that all surfaces are properly monitored and reduces the workload of the worker. The device, processor and/or system may calculate an overall risk score based upon these parameters. This score may use a linear regression. The model being applied may be used to calculate an overall risk score based upon the actual data collected. Additionally, if a room, for example, is high-risk for a condition, a sensitivity analysis using the above-mentioned model may be executed to discover which variables are most influencing the score. Again, here, the device, processor, and/or system may then optimize which tasks should be performed to lower the risk score and assign the task to an available worker. These tasks might include, for example, adjusting temperature, changing humidity levels, cleaning with certain materials or chemicals, and replacing or cleaning a surface or a particular region in a room, among other options.

For an environmental resource, which may have most recently cleaned the room (e.g., newborn intensive care unit (NICU), intensive care unit (ICU), surgery ward, or cancer ward), various data points may be detected and/or obtained. These data points may include, for example, the amount of time they have been employed in their current position, whether they washed their hands within the past hour, what conditions they have been exposed to throughout the day, their age, and health. If the healthcare worker opts-in to provide their healthcare data, the data may include the same data related to patient data (e.g., age, gender, ethnic make-up, cardiac, respiratory, insulin/glucose, etc.). A device, processor and/or system may use this data to calculate an overall risk score based on the parameters that lower the risk for the environmental resource to both acquire a condition themselves and/or spread a condition to a patient. This score may initially be based on a linear regression. Additionally, if an environmental resource is determined to be ‘high-risk’ for spreading a condition, a sensitivity analysis using this model may be created and executed to discover which variables are most influential to the overall score. The device, processor, and/or system may then optimize which tasks should be performed to lower the risk of spreading an infection and send these actions to an available worker or the head nurse/administrator to assign to a worker. Such actions might include changing the workflow of the environmental resource to avoid certain rooms, having the environmental resource wash their hands, performing new tasks, learning new protocols to follow, or using different or more varied supplies for cleaning and patient treatment. Additionally, based on the circumstances, an algorithm according to an exemplary embodiment, may isolate and identify particular aspects of a risk assessment such that investment or increased investment in new material types or surfaces is prudent with respect to the identified aspects; especially if there is a recurring matter that produces increased costs and infection risk to the hospital, its workers and its patients.

According to an exemplary embodiment, information about patient, environmental, and environmental resource data may be passed through a classification model to identify high risk environments, e.g., rooms. High risk environments may be determined as high risk based on risk scores that derive from a combination of individual HCPs, patient EMRs, real-time data (e.g., telemetry) care protocols, disease/issues, etc. If a room is low risk (e.g., scores below a threshold value), there may not be any recommendations generated by a device, processor, and/or system. If a room is identified as high risk (e.g., scores above a threshold value), however, the device, processor, and/or system may loop through a risk score/classification process to simulate a predefined action to identify which action would optimize the reduction of the risk of a HAC. The device, processor, and/or system may curate a digital list of next steps that are generated and provided to workers, for example, via a mobile application. At this phase, scheduling data for employees may be factored-in to automate scheduling of high priority action-items and, in addition, data may continuously be collected and input into an ML algorithm so that the classification model continually trains itself.

According to yet another exemplary embodiment, the patient risk score, environment risk score, and environmental resource risk score may be combined and passed into a classification model such as a logistic regression. The score that is produced may be the aggregate risk of any given patient. It will be based upon a point-scale normalized between 0 and 100. Such may allow the algorithm to identify whether a patient is high risk or not. High-risk patients may be stack-ranked against each other to determine the priority of the patient, and the raw environmental data and patient data may be passed into a sensitivity analysis. This sensitivity analysis may simulate an action on the raw data point (for example, using a certain cleaning material would drop bacterial levels by X amount). These new data points may be utilized by repeating some actions to determine the actions which will most reduce the overall risk score. The simulated actions, resultant scores, and associated costs may be stored in a hashmap. This hashmap may then select, cause to be selected, or be used to select the optimal action which will most reduce risk of acquiring a condition within the constraints given (e.g., individuals involved, working shift, time, resourcing, costs, etc.).

Once the next-actions are identified, the system may automatically assign them to relevant employees to perform the actions, or system-based commands may be transmitted to different components of the health-care environment so that automated action may be taken to minimize the risk of a HAC. From here, a monitoring capability may be used to determine whether tasks or system-based actions are performed and completed in accordance with the above-described exemplary embodiment.

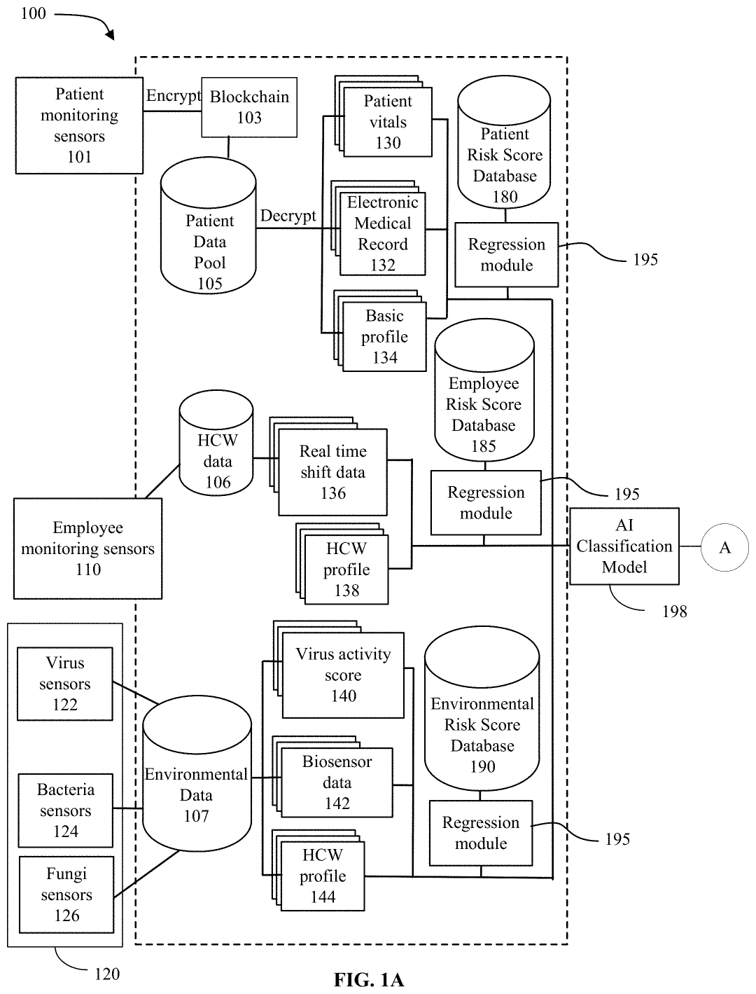

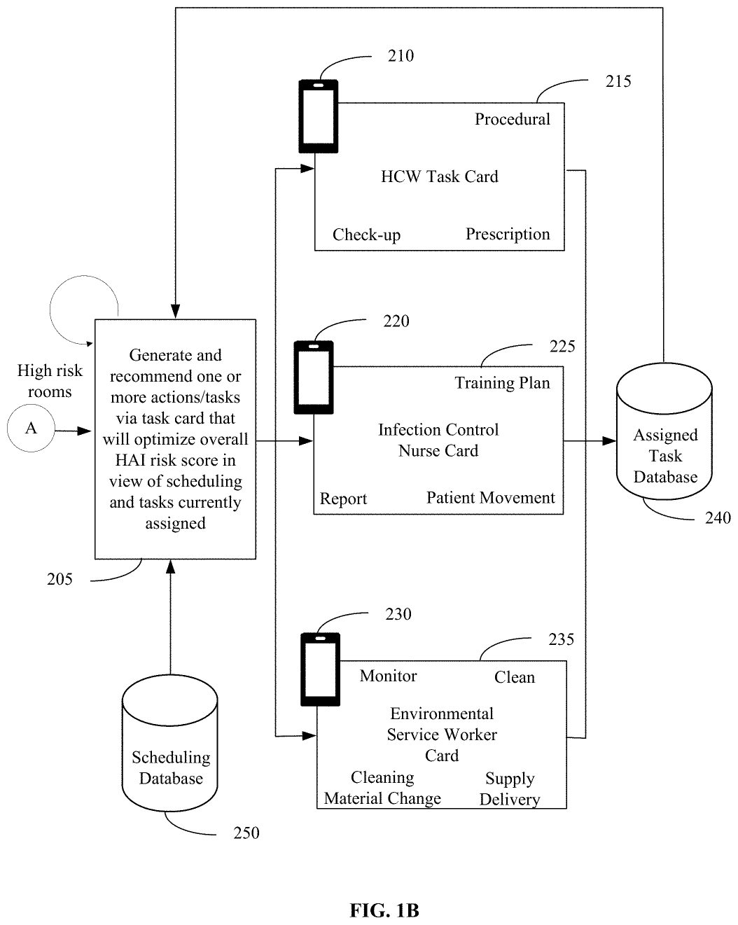

Referring now to FIG. 1A, a system 100 according to another exemplary embodiment is shown, where nodes in the system 100 may be communicatively coupled via a wired and/or wireless connection. The nodes within the system 100 may be, for example, patient monitoring sensors 101, environment monitoring sensors—for purposes of describing this exemplary embodiment, the environment monitoring sensors will be specifically referred to as employee monitoring sensors 110 even though the environment monitoring sensors should not be considered to be necessarily limited to monitoring employees-, and environment monitoring sensors 120, which include virus sensors 122, bacteria sensors 124, and fungi sensors 126. These sensors respectively detect and sense information, which is collected and analyzed.

The patient monitoring sensors 101 may include, but are not limited to, blood pressure monitors, temperature monitors, and electronic health record (HER) systems. The patient monitoring sensors 101 may be physically integrated into a mobile device, or may be separate from a mobile device and may communicate with the mobile device through wired and/or wireless communication means and associated protocols (e.g., Ethernet, Bluetooth®, Wi-Fi®, WiMAX, LTE, etc.) to affect such communication. The mobile device may be, for example, a cell phone, personal digital assistant (PDA), tablet, laptop, or other portable computing device.

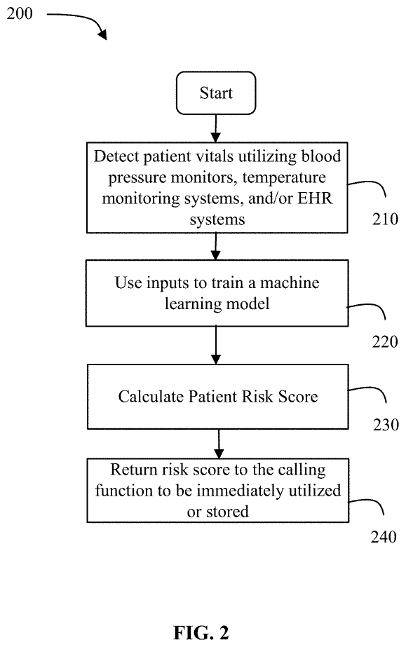

Based on patient data sensed or detected by the patient monitoring sensors 101, a patient risk score may be calculated according to an exemplary embodiment. A method 200 for analyzing and calculating a patient risk score, according to an exemplary embodiment, is shown in FIG. 2 below.

The patient data that is obtained, sensed, detected and/or acquired by patient monitoring sensors 101 may be encrypted, encapsulated, and stored in a blockchain module 103, as a list of block chain transactions. The block chain module 103 may include a health block chain specifically configured for recording and storing data related to a patient—there are potential exemplary advantages to using blockchain over other protocols (e.g., Fast Healthcare interoperability Resources (FHIR) security protocol); such exemplary advantages include, but are not limited to, persistence, synchronization, identity, provenance, and consent as described at https://medium.com/the-future-is-electric/blockchain-could-displace-fhir-for-a-subset-of-healthcare-integration-d8ce5a550b2b. A patient data pool 105 may acquire data from the blockchain module 103 and store the patient data, whereby each blockchain transaction references the location of the health data in the patient data pool. The patient data pool 105 may contain basic profile information 134 about the patient, electronic medical record (EMR) information 132 about the patient, and information related to the patient vitals 130. The basic profile information 134 may include, for example, age, gender, ethnicity information, and occupation information. The EMR information 132 may include medical history data, information on prescriptions, test results, and information related to medical encounters. The patient vitals data 130 may include, for example, respiration rate, blood pressure, body temperature, and telemetry information (e.g., pulse rate or Sp02 information).

The security and privacy of data maintained via the blockchain 103 may be protected by storing patient identification information separate from other specific information on the patients. For example, there may be two databases, in which one database has a block chain key/ID and a separate database having medical records on patients. Each blockchain key may correspond to respective medical record data. The blockchain key in one database, using existing blockchain technology, may be used to access corresponding encrypted data stored in the second database. That is, patient data may be stored in a dispersed database model. Any personally identifiable information may be disassociated from the medical records themselves utilizing blockchain technology. One database may be used to store a blockchain key/ID associated to a given patient. This blockchain key may correspond to data in the second database that will only be accessible with this particular blockchain key.

The above-described patient data pool 105 may be embodied as any type of storage means, including memory. The patient data pool 105 may be embodied as any type of volatile or non-volatile memory or data storage capable of performing the functions described herein. In operation, the patient data pool may store various data and software. The patient data pool 105 may be provided on the patient monitoring sensors 100 or may be part of a separate device and/or server communicatively coupled to the patient monitoring sensors 101. The patient data pool 105 may be provided on the same computing device that calculates the patient risk score.

According to an exemplary embodiment, the above-described employee monitoring sensors 110 may sense, detect and collect data related to an employee. The employee data may include information on the location of the employee, handwashing information related to the employee, or other information related to the hygiene of the employee. Such employee data may be captured using a mobile device, including, for example, a smart watch, or the location services provided on the mobile device. The data that is sensed, detected, and/or collected may be stored in an HCW data store 106. The HCW data store 106 may contain HCW profile information 138 about the employee and/or real-time shift information 136 related to the employee. The HCW profile information 138 may include, for example, age, gender, ethnicity information, and information on duties performed by the employee.

The employee monitoring sensors 110 may include, but are not limited to, activity sensors (e.g., handwashing sensors, movement sensors, etc.) location sensors, etc. Different types of sensors may be used to detect and collect data related to an employee. The employee may be a health care worker that is responsible for a particular patient (e.g., a nurse, medical technician, or doctor).

The employee monitoring sensors 110 may be physically integrated into a mobile device, or may be separate from a mobile device and may communicate with the mobile device through wired and/or wireless communication means. The mobile device may be, for example, a cell phone, personal digital assistant (PDA), tablet, laptop, or other portable computing device.

According to yet another exemplary embodiment, environmental data may be captured, sensed, detected and/or acquired via the environment monitoring sensors 120. Environment monitoring sensors 120 may include, but are not limited to, virus sensors 122 (e.g., interferometer), bacteria sensors 124 (e.g., osmolarity sensor) or fungi sensors 126 (e.g., multi-optical sensor). The environment monitoring sensors 120 may be physically integrated into a mobile device, or may be separate from a mobile device and may communicate with the mobile device through wired and/or wireless communication means and associated protocols (e.g., Ethernet, Bluetooth®, Wi-Fi®, WiMAX, LTE, etc.). The mobile device may be, for example, a cell phone, personal digital assistant (PDA), tablet, laptop, or other portable computing device. The environment sensors may be provided in a heating, ventilation, and air conditioning (HVAC) system, ATP readers, thermostats, and light systems. The environment monitoring sensors 120 may detect information related to the bacterial contamination levels of various objects in a room (e.g., tables, utensils, health-care related objects, entertainment devices, etc.). The data that is captured, sensed, detected and/or acquired via the environment monitoring sensors 120 may be stored in an environmental data store 107. A real-time location system (RTLS) may be implemented according to an exemplary embodiment to automatically locate different actors (e.g., health care workers, employees, patients) and machines that are prevalent in the environments described herein. Such a RTLS may be incorporated into one or more exemplary embodiments so that the location of all actors and machines may be ascertained in real-time, which may allow the methods, systems, and apparatuses described herein to more efficiently and effectively reduce the occurrence of undesirable conditions.

The environmental data store 107 may contain HCW profile information 144 about the employee, biosensor data 142, and/or virus activity score data 140. The HCW profile information 144 may include, for example, age, gender, ethnicity information, and information related to duties performed by an employee.

The above-discussed data that is captured, sensed, detected and/or acquired via the patient monitoring sensors 101, employee monitoring sensors 110 and environment monitoring sensors 120 may be used to calculate an overall risk score which is then used by the system 100 to determine appropriate action(s) to be taken. For example, appropriate actions may be performed automatically based on system-issued commands or may be used to indicate the types of actions to be taken by users of the system. The above-described sensors may be incorporated into various different objects, devices, and machines. For example, one or more of the above-described sensors may be incorporated into a bed.

According to an exemplary embodiment, machine learning algorithms may be used to train the machine learning model of the system 100 based on the data that is received via the patient monitoring sensors 101 and/or any of the other sensors 110, or 120. Regression modules 195 may employ ML algorithms which include one or more of a linear regression algorithm, a logical regression algorithm, or a combination of different algorithms, to train system 100. A neural network may also be used to train the system based on the received data.

A logistic regression, linear regression, or neural network algorithm may, individually or collectively, be applied to the received data. Then, in future instances of data capture, a software monitoring system according to an exemplary embodiment may track the correlation between the variables and the occurrence of infection to train the ML model and reduce root-mean-squared error. The ML algorithms may also be applied to, e.g., an AI classification model 198 to determine variables that result in a measurable impact to the risk of infection. The AI classification model 198 may output impactful risk factors that merit modulation, in order to decrease the risk of patients acquiring a HAI. Data generated based on the ML algorithm(s) may reveal the highest impact variables that lead to increased rates of HAC/HAL

For example, according to an exemplary embodiment, a sensitivity analysis may be run for rooms that are classified as high risk. This sensitivity analysis may simulate a series of potential actions. The outcomes of this analysis may determine the highest impact variables that lead to the increased rates of HAC/HAL so as to isolate the activities in order to control these variables to improve conditions for the patients. This data may inform a user (e.g., a hospital, its employees, etc.) which variables to modulate through changes to employee protocols, patient protocols, and/or environmental changes to lower the risk of HAIs. Lowering the risk of HAIs often lowers associated hospital costs.

According to yet another exemplary embodiment, at the beginning of each shift, a device, processor, or system may initiate a risk calculation for each room. That is, the device, processor, or system may initiate several risk score calculations. The device, processor and/or may combine real time patient data to calculate a patient risk score using a linear regression specific to a certain HAC. Core patient data for each algorithm may include the patient's gender, age, ethnic makeup, allergies, current medications, previous procedures or surgeries, duration of stay in hospital room, body measurements (e.g., height, weight, body fat, body mass, lean body mass, waist, etc.), cardiac data (e.g., resting heart rate, exercise heart rate, heart rate variability, v-tach, a-fib, bradyarrhythmia, high/low heart rate occurrences, blood pressure, stress test data), respiratory data (e.g., forced expiratory volume, SPO2, forced vital capacity, peak expiratory flow rate), insulin and glucose data, and blood and skin data (e.g., electrodermal activity, blood alcohol content, insulin delivery, oxygen saturation, peripheral perfusion index, UV index), reproductive health data (e.g., basal body temperature, cervical mucus quality, menstruation cycle, ovulation test result, whether or not currently pregnant, sexually active, and any other relevant health data available). The system may combine this patient data with environmental data to calculate an environmental risk score for each room or open patient space (e.g., emergency room (ER)) using a linear regression for each HAC. This environmental data may include ATP readings for mandated surfaces in the room, the humidity, air temperature, amount of UV, and other environmental data. The system may feed real-time EVS worker behavioral data into a linear regression to calculate an environmental risk score for each hospital acquired condition. This data may include how many hours a person has worked in the week, the amount and types of training completed, age, demographic of the worker, and any additional opt-in health data the employee consents to offer to the system for training, recommendation, and employee learning opportunities.

Turning now to FIG. 1B, in block 205, once a high-risk room and one or more risk factors are identified with respect to a particular patient and/or room, by, for example, an AI classification model 198, one or more actions/tasks may be generated and recommended to a HCW, infection control nurse, and/or an environmental service worker. According to the instant exemplary embodiment, several actions/tasks may be generated that either suggest care delivery modifications and/or identify specific HCW tasks and/or actions. The actions may be transmitted via apps on the HCW, infection control nurse, and environmental service worker's respective devices 210, 220, and 230, respectively. The devices 210, 220, 230 may include, but are not limited to, mobile phones, heads-up display, wearable, laptops, desktops, or tablets. The suggested actions/tasks may be presented via cards or notifications 215, 225, 235 in the apps of the respective devices, or via a short messaging service (SMS). The cards may be user interfaces that group information in a flexible-sized container visually resembling a playing card. The HCW, infection control nurse, and/or environmental service worker may perform the instructions on their respective cards or other messages to ensure that the risk factors identified by the AI classification model 198 are mitigated or eliminated. The actions/tasks that are generated and recommended may be stored in an assigned task databased 240.

According to an exemplary embodiment, the data stored in the assigned task database 240 and a scheduling database 250 may be real-time processed as part of one or more machine learning algorithms to modify existing algorithms being executed at block 205, to generate the actions/tasks of the HCW, infection control nurse, and an environmental service worker. The operations reflected in FIG. 1B may be executed and/or implemented by a computing device, processor, and/or system according to an exemplary embodiment.

In FIG. 2, patient information may be obtained, sensed, detected and/or acquired via patient monitoring sensors 101. In block 210, the above-described sensors may be used to detect and collect patient vitals. In block 220, patient vitals data that is collected may be used to train an ML model based on one or more ML algorithms as described above. In block 230, a patient risk score may be calculated based on information received via the patient monitoring sensors 101. The patient risk score may be calculated for a particular moment in time. The patient risk score may be calculated and/or determined at the patient monitoring sensors 101 or at a backend server to which data is transmitted from the patient monitoring sensors 101. In block 240, the calculated risk score may be returned to a calling function to be utilized and/or stored. The patient risk score as well as other calculated risk scores may be stored in risk score databases (e.g., patient risk score database 180, employee risk score database 185, and environment risk score database 190). The databases may also store data related to the acuity of patients, employees, and/or other health care workers/providers.

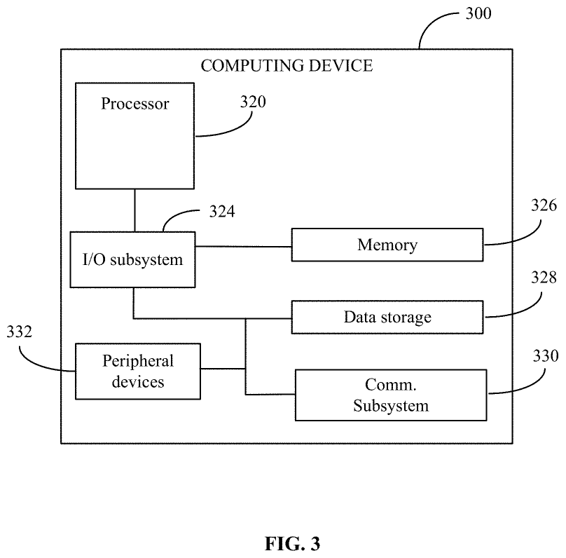

Referring now to FIG. 3, an illustrative computing device 300 (e.g., a server device) for calculating a patient risk score may include a processor 320, a memory 326, a data storage 328, a communication subsystem 330, and an I/O subsystem 324. Additionally, in some embodiments, one or more of the illustrative components may be incorporated in, or otherwise form a portion of, another component. For example, the memory 326, or portions thereof, may be incorporated in the processor 320 in some embodiments. The computing device 300 may be embodied as, without limitation, a mobile computing device, a smartphone, a wearable computing device, an Internet-of-Things device, a laptop computer, a tablet computer, a notebook computer, a computer, a workstation, a server, a multiprocessor system, and/or a consumer electronic device.

The processor 320 may be embodied as any type of processor capable of performing the functions described herein. For example, the processor 320 may be embodied as a single or multi-core processor(s), digital signal processor, microcontroller, or other processor or processing/controlling circuit.

The memory 326 may be embodied as any type of volatile or non-volatile memory or data storage capable of performing the functions described herein. In operation, the memory 326 may store various data and software used during operation of the computing device 300 such as operating systems, applications, programs, libraries, and drivers. The memory 326 is communicatively coupled to the processor 320 via the I/O subsystem 324, which may be embodied as circuitry and/or components to facilitate input/output operations with the processor 320, the memory 326, and other components of the computing device 300.

The data storage device 328 may be embodied as any type of device or devices configured for short-term or long-term storage of data such as, for example, memory devices and circuits, memory cards, hard disk drives, solid-state drives, non-volatile flash memory, or other data storage devices. With respect to calculating and determining a patient risk score, the data storage device 328 may store the patient risk score database 180 and/or the above-discussed patient data pool 105.

The computing device 300 may also include a communications subsystem 330, which may be embodied as any communication circuit, device, receiver, transmitter, transceiver, or collection thereof, capable of enabling communications between the computing device 300 and other remote devices over a computer network (not shown). The communications subsystem 330 may be configured to use any one or more communication technology (e.g., wired or wireless communications) and associated protocols (e.g., Ethernet, Bluetooth®, Wi-Fi®, WiMAX, LTE, etc.) to affect such communication.

As shown, the computing device 300 may further include one or more peripheral devices 332. The peripheral devices 332 may include any number of additional input/output devices, interface devices, and/or other peripheral devices. For example, in some embodiments, the peripheral devices 332 may include a display, touch screen, graphics circuitry, keyboard, mouse, speaker system, microphone, network interface, and/or other input/output devices, interface devices, and/or peripheral devices. The computing device 300 may also perform one or more of the functions described in detail herein and/or may store any of the databases referred to herein.

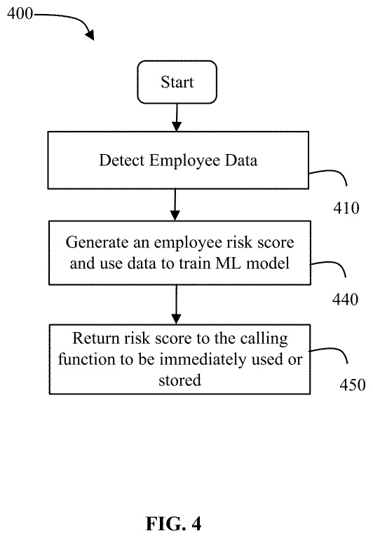

Based on employee information sensed by the employee monitoring sensors 110, an employee risk score may be calculated according to an exemplary embodiment. A method 400 for analyzing and calculating an employee risk score, according to an exemplary embodiment, is shown in FIG. 4.

In block 410, the above-described employee monitoring sensors may sense, detect and collect data related to an employee. In block 440, the data that is collected may be used to train an ML model based on one or more of the ML algorithms described in detail above, and an employee risk score may be generated.

The employee risk score may be calculated and/or determined at the employee monitoring sensors 110 or at a backend server (e.g., computing device 300) to which data is transmitted from the employee monitoring sensors 110. In block 450, the calculated employee risk score may be returned to the function that called for the calculation or may be stored for subsequent use.

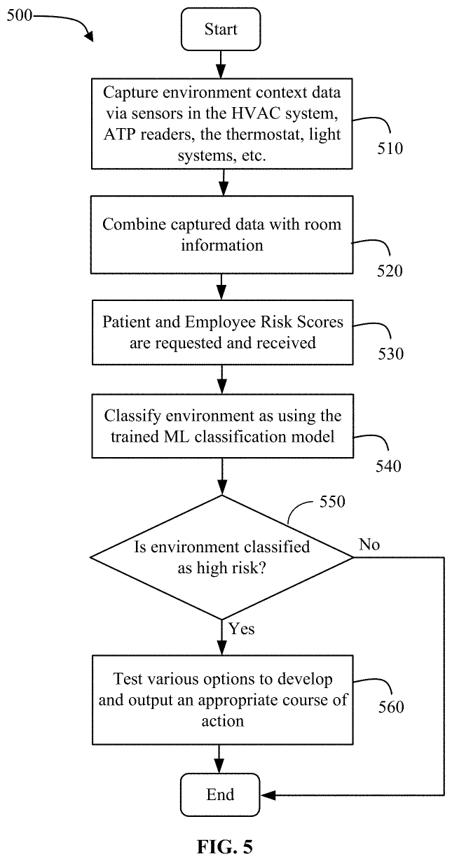

Based on environmental data sensed by environment monitoring sensors 120, an environment risk score may be calculated according to an exemplary embodiment. A method 500 for capturing, analyzing and/or calculating an environment risk score, according to an exemplary embodiment, is shown in FIG. 5.

Turning now to FIG. 5, in block 510, one or more of the above-described environment monitoring sensors 120 may be used to detect and collect environment context data. In block 520, data that is collected may be combined with room information such as room location, room size, and/or number of patients in a particular room.

In block 530, the patient risk score and the employee score may be requested and received. In block 540, the above-described ML model may be used to classify a particular environment (e.g., a room). The patient risk score and the employee risk score may be used to make this classification. In block 550, a determination is made as to whether the environment is high risk or not. In block 560, if an environment is identified as high risk, various courses of action may be tested so as to develop and output an optimal course of action.

The risk scores that are respectively calculated according to methods 200, 400, and 500 may be used to calculate an overall risk score which may be used to determine actions and/or protocols that may be taken to reduce (e.g., minimize) the possibility of HACs and HAIs.

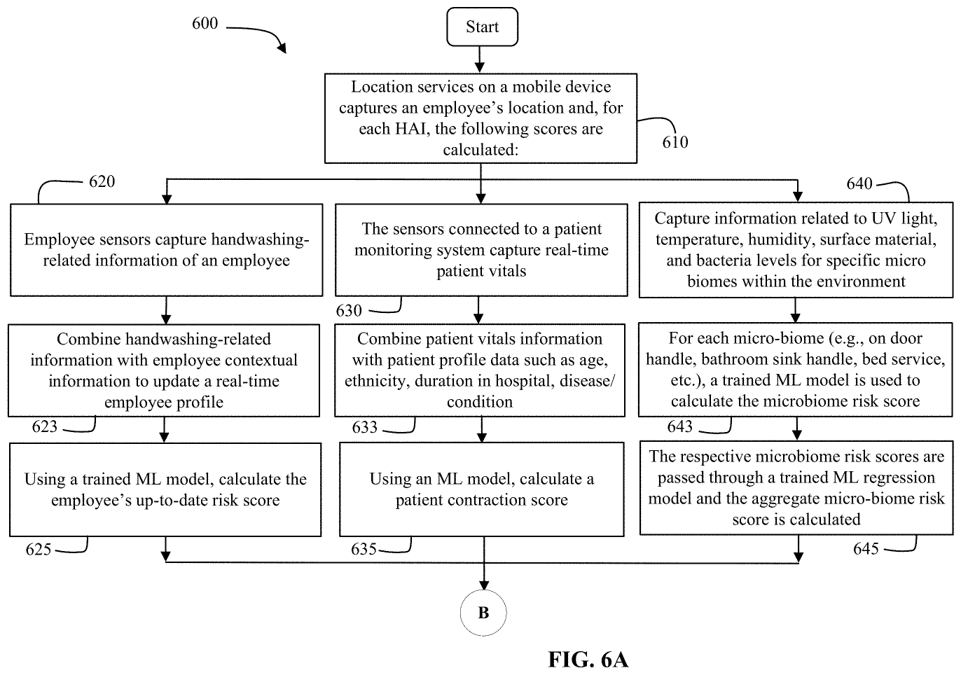

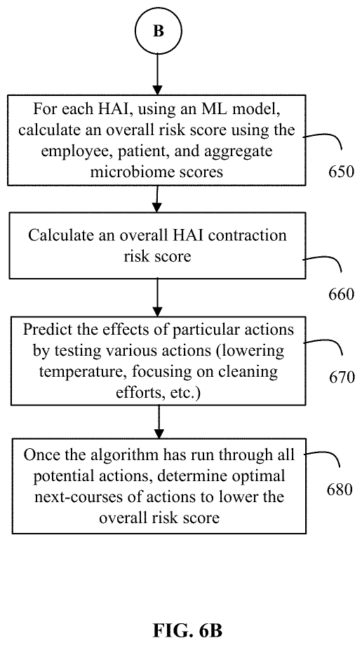

FIGS. 6A-6B illustrate another method 600 for minimizing the occurrence of HAIs, according to another exemplary embodiment. In block 610, location services on a mobile device may capture an environmental resource's location once an environmental resource enters a specific room. For purposes of this exemplary embodiment, the environmental resource will be explicitly referred to as an employee, although, as indicated above, an environmental resource may not be so limited. For each HAI, various risk scores may be calculated, including, but not limited to, an employee risk score, a patient risk score, and an environment risk score (e.g., aggregate microbiome score).

To calculate an employee risk score, in block 620, one or more sensors may capture information related to when an employee washes their hands. For example, the sensor(s) may capture information indicating whether an employee washes their hands before they begin their cleaning workflow. In block 623, the handwashing data may be combined with employee contextual information. The employee contextual information may include, for example, the career level of the employee, years of experience, hours worked, past compliance history, etc. Combining the handwashing information with the contextual employee information may be used to automatically update a real-time employee profile. In block 625, one or more of the above-described ML models may be used to calculate an up-to-date employee risk score.

To calculate a patient risk score, in block 630, one or more sensors may capture information related to the patient vitals. For example, the sensors may capture real-time data points such as, for example, patient heart rate, patient temperature, and/or patient white blood cell count. In block 633, the information related to the patient vitals may be combined with patient profile information. The patient profile information may include, for example, the age of the patient, ethnicity data, duration in hospital, disease/condition information of the patient, historical susceptibility to infection information, etc. In block 635, one or more of the above described ML models may be used to calculate an up-to-date patient risk score, which relates to the likelihood of a patient contracting, for example, a HAI.

To calculate an aggregate micro-biome risk score, in block 640, one or more environment sensors may capture information related to the environment. For example, the one or more environment sensors may detect and capture information on ultra-violet (UV) light, environment temperature, environment humidity, surface material data, and/or bacteria levels for particular micro-biomes within the environment. The environment may be a patient's room, bed area, portion of a floor-level of a hospital, etc. In block 643, for each micro-biome, a trained ML model calculates the specific risk score of respective micro-biomes. A micro-biome may be a particular community of microorganism on a door handle, bathroom sink handle, crevice, etc. In block 645, the respective micro-biome risk scores may be passed through the above-mentioned ML model and an aggregate micro-biome risk score may be calculated.

In block 650, using an ML model, the above-mentioned employee risk score, patient risk score, and/or aggregate micro-biome risk score may be used to calculate an overall risk score for a particular HAI. The patient risk score, employee risk score, aggregate microbiome risk score, and/or the overall risk score, when used with an ML model, may enable the calculation of an overall HAI contraction risk score (block 660). In block 670, a process to test various actions may be used to predict the effects of a particular action. The process may be iterative, and the various actions may include, but are not limited to, lowering temperature in the environment, focusing on better cleaning efforts, etc. In block 680, once the algorithm(s) for implementing block 670 has analyzed all potential actions, one or more optimal courses of action may be recommended to lower the overall risk score of the particular environment.

The methods shown in FIGS. 2 and 4-6 may generally be implemented in a computing device or system. The computing device or system may be a user level device or system or a server-level device or system. More particularly, the methods may be implemented in one or more modules as a set of logic instructions stored in a machine or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the methods of FIGS. 2 and 4-6 may be written in any combination of one or more programming languages, including an object-oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, and/or other structural components that are native to hardware (e.g., host processor, central processing unit/CPU, microcontroller, etc.).

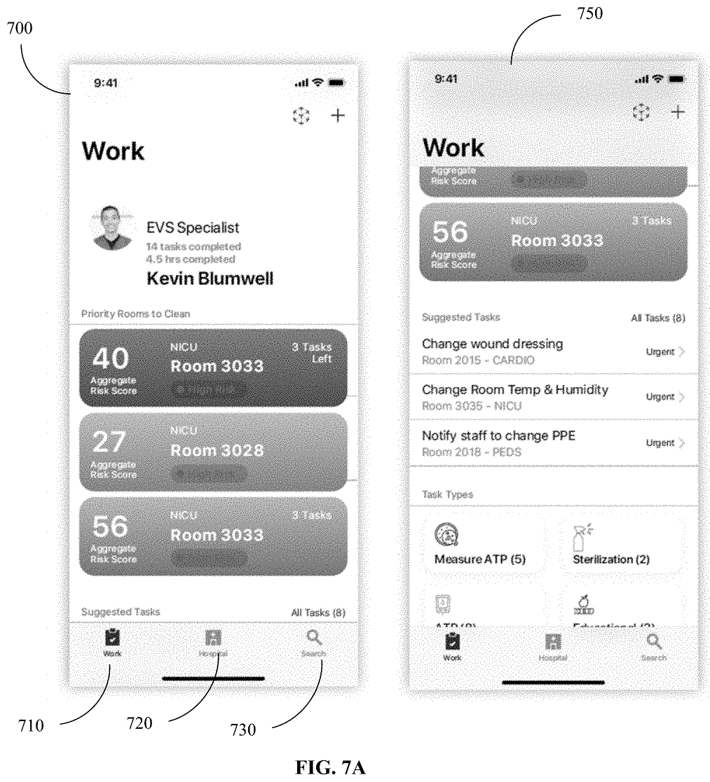

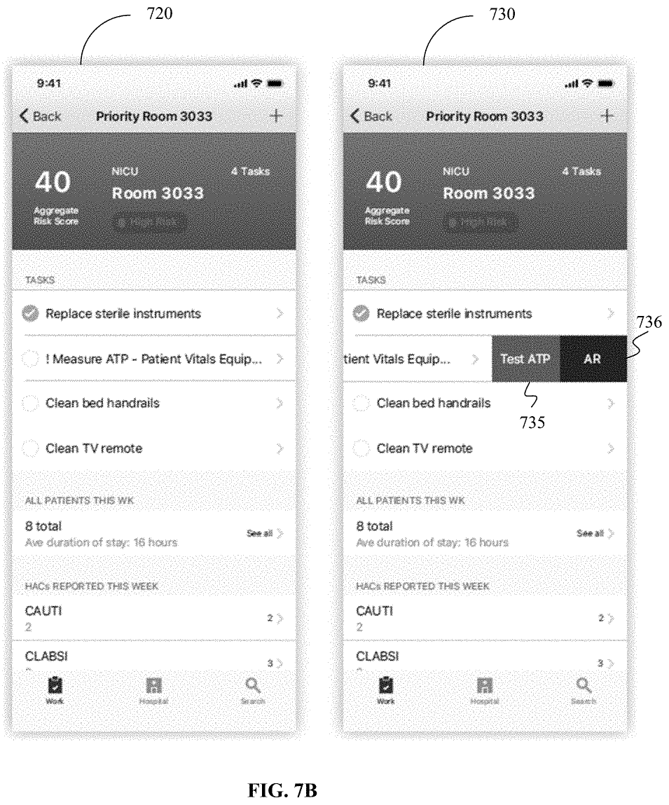

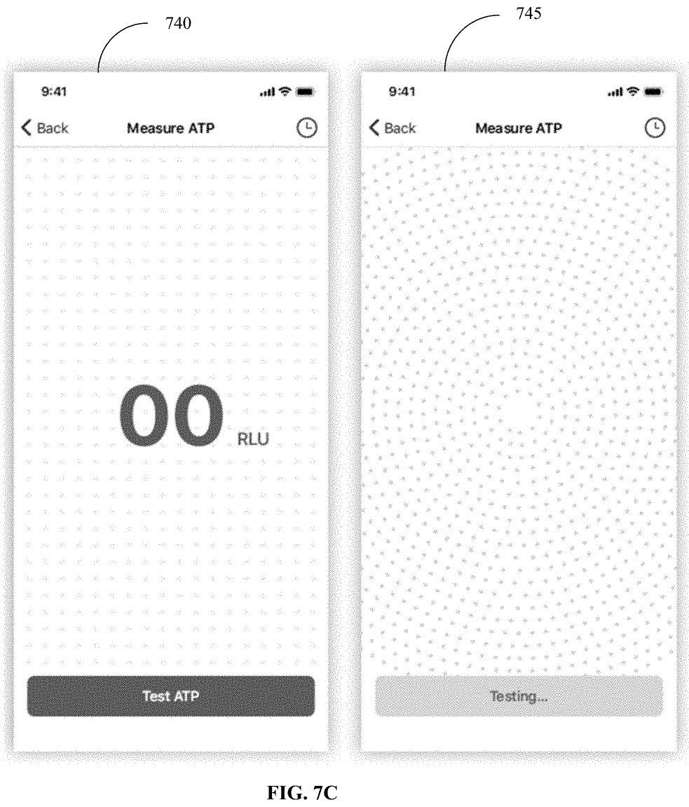

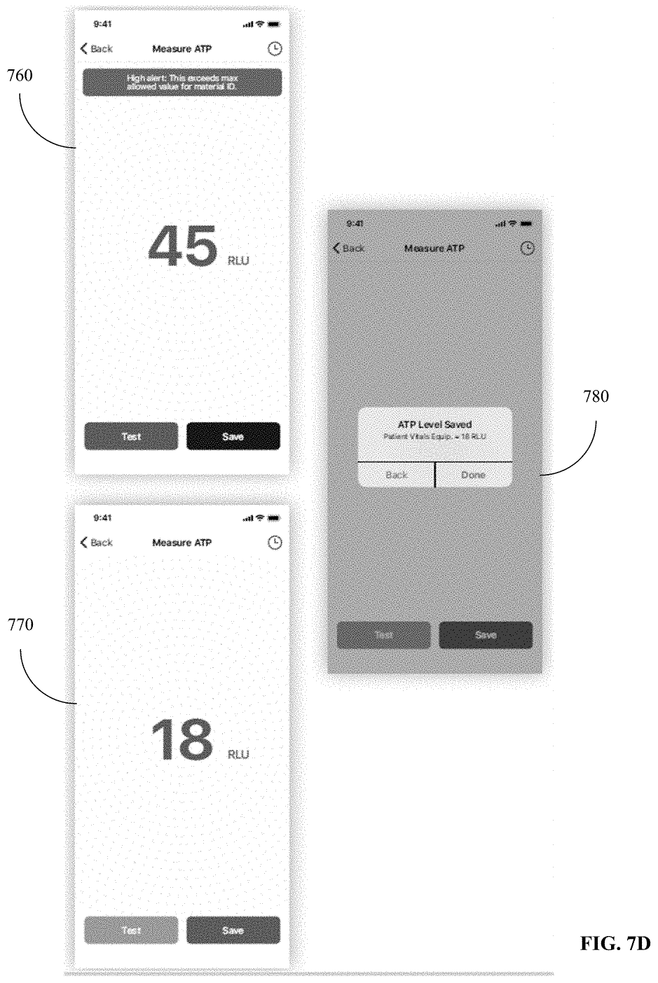

Turning now to FIGS. 7A-9, these figures illustrate interfaces via which EVS workers, nurses, and infection control officers may obtain and input a limited set of information in a specific manner. The specific layout of the illustrated interfaces may result in improved functionality at a backend server by streamlining and limiting the nature of the information that a particular user may input, and is particularly important in urgent care environments, where computers, computer systems, and processors must operate to render decisions in the best interest of patients and care-givers in a fast, efficient, and effective manner. The interfaces of FIGS. 7-9 also serve a function of educating and informing human action within different environments.

FIG. 7A, for example, illustrates an interface having an upper part 700 and lower part 750—the lower part 750 of the interface is the view a user sees after ‘scrolling down.’ An EVS worker may see this interface in an app having functionality specific to their position and duties. The tasks/actions that are generated according to exemplary embodiments, and as detailed above, may be illustrated in the specific manner indicated in interfaces 700, 750. The EVS worker may be able to view the necessary tasks to be undertaken (ranked by priority and room) in the ‘Work’ tab 710 of the app. The tasks may be ranked based on the calculated risk factors or aggregate risk scores. Such ranking may be performed using a machine learning algorithm according to an exemplary embodiment. The app may present other tabs to the EVS worker, including but not limited to a ‘Hospital” tab 720 and a ‘Search’ tab 730. The tabs may be presented in a separate section of the interface, e.g., the “Suggested Tasks” section.

The lower part 750 of the interface shows in specific manner the system-generated suggested tasks according to an exemplary embodiment. The EVS worker, based on their training, may then discern whether the algorithmically and automatically generated tasks/actions are to be followed.

The above-described “Hospital” tab 720 may be where the EVS worker can see the overall hospital cleaning status and use this information to determine any hospital-wide risks or dangers. The ‘Search’ tab 730 may enable an EVS worker to search a database that includes all the active tasks, room data, and patient data to inform best practices with respect to minimizing the risk of acquiring HACs or HAIs.

FIG. 7B illustrates similar interfaces 720, 730 showing tasks such as ‘Clean bed handrails’ and ‘Clean TV remote’. An EVS worker may measure the adenosine triphosphate (ATP) levels of the bed handrails and the remote using the app and the equipment on which the app is executed or to which the app is connected. ATP may indicate a unit of energy in all living cells, which may be used to determine if surfaces and water sources are clean. Using the specific layout of interface 730, for example, an EVS worker may activate measurement of ATP levels of specific objects by selecting one of the ‘TEST ATP’ button 735 or ‘Augmented Reality (A/R)’ button 736 in the interface. Data obtained and/or detected using A/R may be fed back into the system according to an exemplary embodiment. FIG. 7C shows interfaces that are displayed when the ‘TEST ATP’ button 735 is selected. Interface 740 may be displayed just prior to launching the ATP test, and interface 745 may be displayed after the test launch. FIG. 7D illustrates interfaces 760, 770 of an EVS worker's device with respect to different objects whose ATP levels are measured. Interface 780 shows an interface once detected ATP levels are saved.

According to an exemplary embodiment, an EVS worker may record ATP levels for objects in an environment while completing some of their tasks, to ensure that the cleanliness of the environment and/or objects meet CDC desired standards. As indicated above, A/R may be implemented to perform the measurements. The ATP measurements may be recorded using, for example, a luminometer when the above-described app interfaces an apps are communicatively coupled to the luminometer.

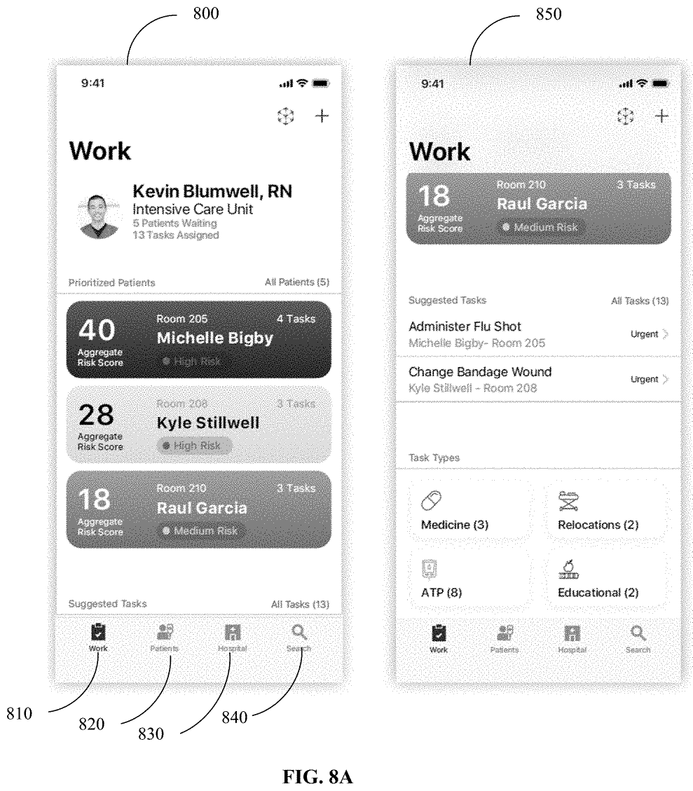

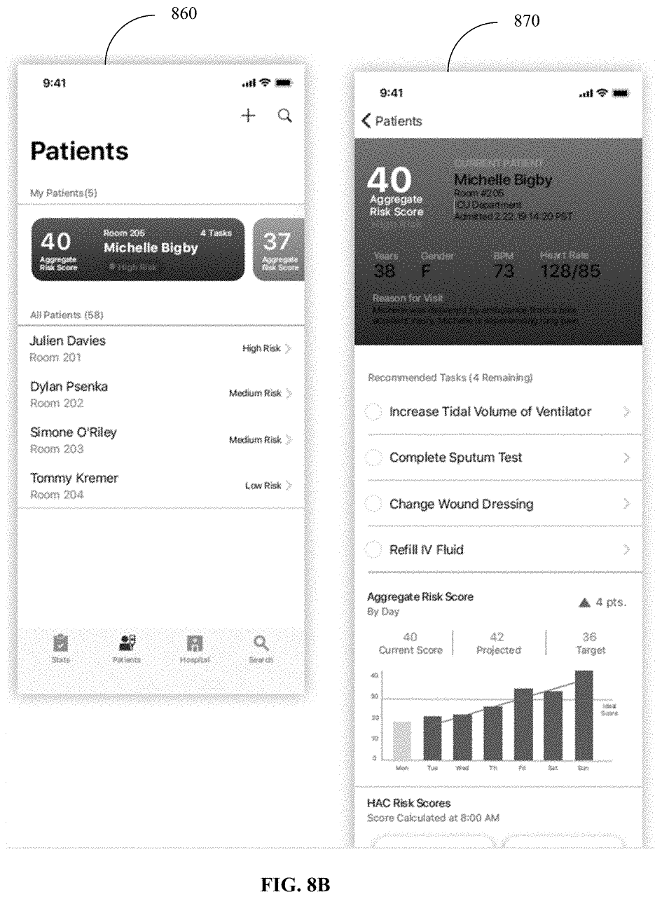

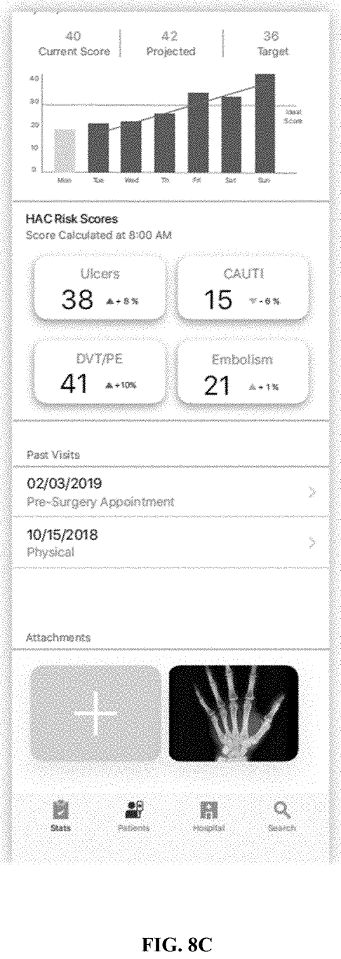

FIG. 8A, according to an exemplary embodiment, illustrates an interface having an upper part 800 and lower part 850—the lower part 850 of the interface is the view a user sees after ‘scrolling down.’. The tasks/actions that are generated according to exemplary embodiments, and as detailed above, may be illustrated in the specific manner indicated in interface 850. The nurse may be able to view the necessary tasks to be undertaken (ranked by priority and patient) in the ‘Work’ tab 810 of the app. The tasks may be ranked based on the calculated risk factors and aggregate risk scores. Such ranking may be performed by implementing a machine learning algorithm according to an exemplary embodiment. The app may present other tabs to the nurse, including but not limited to a ‘Patients” tab 820, a ‘Hospital’ tab 830, and a ‘Search’ tab 840. The tabs may be presented in a separate section, e.g., the “Suggested Tasks” section.

The “Patients” tab 820 may be where the nurse can see a list of his/her own patients. The ‘Hospital’ tab 830 may enable a nurse to view aggregate stats across an entire department, so that the efficacy of work based on patients' health and frequency of conditions may be reviewed. The ‘Search’ tab 840 may enable a nurse to search for patients or infections across the entire app database.

FIG. 8B illustrates exemplary interfaces 860, 870 when a ‘Patients’ tab 820 is selected. The ‘Patients’ tab may enable a nurse to see all of their patients, drill down into the patient information, tasks, and risk history related to a particular patient, and mark patient tasks as complete. FIG. 8C shows an exemplary interface by which a nurse may view HAC risk scores of a patient by bacteria and infection type.

According to an exemplary embodiment, a nurse may see the top priority patients based on the patients' risk factors, see and choose to add suggest tasks to their day's work list, mark a task as completed to send an update to a database integrated with other hospital software systems on the backend, and/or sort their day's work-list according to, e.g., medicine, relocations, ATP reading, and education.

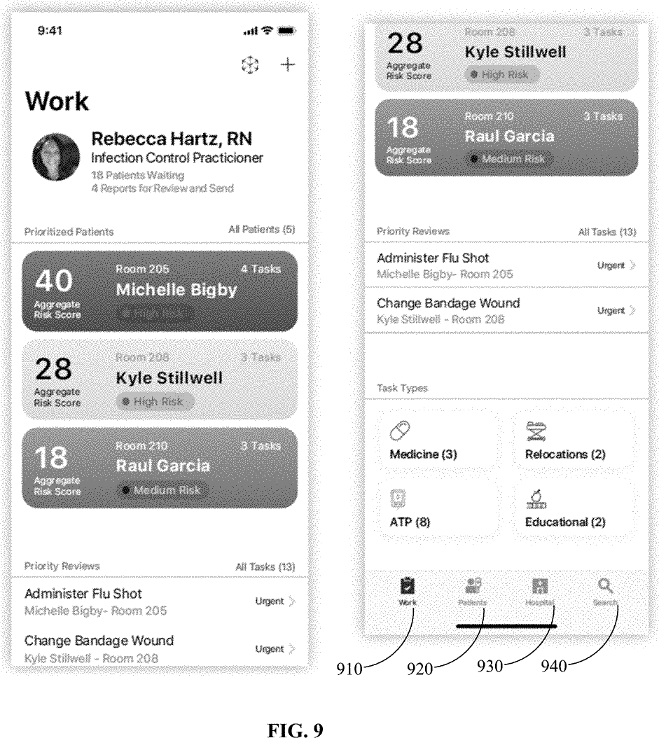

FIG. 9, according to an exemplary embodiment, illustrates different interfaces that an infection control officer (e.g., head nurse, epidemiologist, hospital admin, etc.) may see in an app having functionality specific to their position and duties. The tasks/actions that are generated according to exemplary embodiments, and as detailed above, may be illustrated in the specific manner indicated in interface FIG. 9. The infection control officer may be able to view the first necessary tasks to be undertaken (ranked by priority and patient) in the ‘Work’ tab 910 of the app. The tasks may be ranked based on the calculated risk factors or aggregated risk scores. Such ranking may be performed by implementing a machine learning algorithm according to an exemplary embodiment. The app may present other tabs to the infection control officer, including but not limited to a ‘Patients” tab 920, a ‘Hospital’ tab 930, and a ‘Search’ tab 940.

The “Patients” tab 920 may be where the infection control officer can see and review a list of high-risk patients and all the patients, in order to allocate new tasks with respect to the patients. An infection control officer may also be able to view a list of all patients in the hospital (both current and in the past) via the ‘Patients’ tab 920. The ‘Hospital’ tab 930 may enable an infection control officer to view the overall status of HCP activities to prioritize the activities and allocation of new tasks. The infection control officer may also be able to view statistics to report to the CDC via the ‘Hospital’ tab 930. The ‘Search’ tab 940 may enable an infection control officer to search the room, task, and/or patient database to review the tasks being performed in one room or all the rooms (e.g., sorted according to a particular task type) or find a specific patient.

According to an exemplary embodiment, an infection control officer may see all patients, input details about the hospital, submit a report, and select components for a different report based on priority and data parameters that the CDC requires. The infection control officer may utilize the app and its interface to select a department or room to submit a report about, and may report an issue either related to the patient/room/HCP for a given room or department. Via the illustrated app/interface, an infection control officer may add a patient card to escalate a matter, view HCP information (or room information), add to an existing escalation report, and/or send escalation-related information to a backend server to be handled as a local issue based on an algorithm. Issue escalation may also be sent to CDC for analysis and recommendation.

Where specific details are set forth in order to describe example embodiments, it should be apparent to one skilled in the art that embodiments can be practiced without, or with variation of, these specific details. The description is thus to be regarded as illustrative instead of limiting.

Those skilled in the art will appreciate from the foregoing description that the broad techniques of the one or more embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A system comprising:
one or more sensors configured to:
detect data related to at least one of:
a patient,
an environment to which the patient is exposed, and
an environmental resource,
obtain the detected data, and
transmit the detected data; and
a server configured to receive the detected data, the server comprising:
a receiver configured to:
receive the detected data; and
a processor coupled to a memory, the processor configured to:
calculate a risk score for the detected data,
the risk score related to at least one of:
the patient,
the environment to which the patient is exposed, or
the environmental resource;
calculate an overall risk score based on the risk score for the detected data; and
determine one or more actions to be performed based on at least the overall risk score,
the one or more actions reducing risk value,
the risk value identifying the likelihood that the patient will contract a hospital acquired condition (HAC) or a hospital acquired infection (HAI).

2. The system of claim 1, wherein the detected data relates to each of the patient, the environment to which the patient is exposed, and the environmental resource.

3. The system of claim 1, wherein, prior to the determining the one or more actions to be performed based on the at least the overall risk score, the processor analyzing at least one of the one or more actions to predict an effect of the at least one of the one or more actions.

4. The system of claim 1, wherein the one or more sensors comprise at least one of:
a hand wash sensor configured to detect information related to handwashing of the environmental resource,
a room sensor configured to detect how effective the environmental resource cleans a room of the patient, and
a time sensor configured to detect a duration of time the environmental resource spends in the room of the patient.

5. A method comprising:
receiving detected data related to at least one of a patient, an environment to which the patient is exposed, and an environmental resource, the detected data being detected by one or more sensors;
calculating a risk score for each of the detected data related to the at least one of the patient, the environment to which the patient is exposed, and the environmental resource;
calculating an overall risk score based on the risk score for each of the detected data; and
determining one or more actions to be performed based on at least the overall risk score,
the one or more actions reducing risk value,
the risk value identifying the likelihood that the patient will contract a hospital acquired condition (HAC) or a hospital acquired infection (HAI).

6. The method of claim 5, wherein the detected data relates to each of the patient, the environment to which the patient is exposed, and the environmental resource.

7. The method of claim 6, further comprising acquiring the data using at least a patient monitoring sensor, an environment sensor, and an environmental resource sensor.

8. The method of claim 5, further comprising, prior to the determining, analyzing at least one of the one or more actions to predict an effect of the at least one of the one or more actions.

9. The method of claim 7, wherein the patient monitoring sensor comprises at least one of a respiration monitor, a blood pressure monitor, a body temperature monitor, and a telemetry monitor,
wherein the environment sensor comprises at least one of a virus detector, a bacteria detector, and fungi sensor, and
wherein the environmental resource sensor comprises at least one of a hand wash sensor configured to detect information related to handwashing of an environmental resource, a room sensor configured to detect how effective the environmental resource cleans a room of the patient, and a time sensor configured to detect a duration of time the environmental resource spends in the room of the patient.

10. An apparatus comprising:
a receiver configured to receive detected data related to at least one of a patient, an environment to which the patient is exposed, and an environmental resource; and
logic coupled to the receiver, wherein the logic is implemented in one or more of configurable logic or fixed-functionality hardware logic, the logic configured to:
calculate a risk score for each of the detected data related to the at least one of the patient, the environment to which the patient is exposed, and the environmental resource;
calculate an overall risk score based on the risk score for each of the detected data; and
determine one or more actions to be performed based on at least the overall risk score,
the one or more actions reducing risk value,
the risk value identifying the likelihood that the patient will contract a hospital acquired condition (HAC) or a hospital acquired infection (HAI).

11. The apparatus of claim 10, wherein the detected data relates to each of the patient, the environment to which the patient is exposed, and the environmental resource.

12. The apparatus of claim 11, wherein the detected data is acquired using a patient monitoring sensor, an environment sensor, and an environmental resource sensor, respectively.

13. The apparatus of claim 10, wherein, prior to the determining the one or more actions to be performed based on at least the overall risk score, the logic is configured to analyze at least one of the one or more actions to predict an effect of the at least one of the one or more actions.

14. The apparatus of claim 12, wherein the patient monitoring sensor comprises at least one of a respiration monitor, a blood pressure monitor, a body temperature monitor, and a telemetry monitor,
wherein the environment sensor comprises at least one of a virus detector, a bacteria detector, and fungi sensor, and
wherein the environmental resource sensor comprises at least one of a hand wash sensor configured to detect information related to handwashing of the environmental resource, a room sensor configured to detect how effective the environmental resource cleans a room of the patient, and a time sensor configured to detect a duration of time the environmental resource spends in the room of the patient.

15. A non-transitory computer readable medium comprising a set of instructions, which when executed by one or more processors of a device, cause the device to:
receive detected data related to at least one of a patient, an environment to which the patient is exposed, and an environmental resource;
calculate a risk score for each of the detected data related to the at least one of the patient, the environment to which the patient is exposed, and the environmental resource;
calculate an overall risk score based on the risk score for each of the detected data; and
determine one or more actions to be performed based on at least the overall risk score,
the one or more actions reducing risk value,
the risk value identifying the likelihood that the patient will contract a hospital acquired condition (HAC) or a hospital acquired infection (HAI).

16. The non-transitory computer readable medium of claim 15, wherein the detected data relates to each of the patient, the environment to which the patient is exposed, and the environmental resource.

17. The non-transitory computer readable medium of claim 16, wherein the detected data is acquired using at least a patient monitoring sensor, an environment sensor, and an environmental resource sensor.

18. The non-transitory computer readable medium of claim 15, wherein, prior to the determining the one or more actions to be performed based on the at least the overall risk score, at least one of the one or more actions is analyzed to predict an effect of the at least one of the one or more actions.

19. The non-transitory computer readable medium of claim 17, wherein the patient monitoring sensor comprises at least one of a respiration monitor, a blood pressure monitor, a body temperature monitor, and a telemetry monitor,
wherein the environment sensor comprises at least one of a virus detector, a bacteria detector, and fungi sensor, and
wherein the environmental resource sensor comprises at least one of a hand wash sensor configured to detect information related to handwashing of the environmental resource, a room sensor configured to detect how effective the environmental resource cleans a room of the patient, and a time sensor configured to detect a duration of time the environmental resource spends in the room of the patient.

20. The non-transitory computer readable medium of claim 19, wherein the environment sensor is provided in at least one of a HVAC system, ATP readers, thermostats, and light systems.
